(19) United States
(12) Patent Application Publication
(10) Pub. No.: US 2024/0128758 A1
(43) Pub. Date: Apr. 18, 2024

(54) MOBILE LITHIUM-ION BATTERY ENERGY STORAGE SYSTEMS

(71) Applicant: NOMAD TRANSPORTABLE POWER SYSTEMS, INC., Waterbury, VT (US)

(72) Inventors: Jonathan Edward Bellows, Waterbury, VT (US); Gregg Richard Noble, Saxtons River, VT (US); Stephen P. Hoskins, Waterbury Center, VT (US); Margaret May Dobroth, Bolton, VT (US); Samuel Andrew Gavett, Waitsfield, VT (US); Alex David Perkins, North Ferrisburgh, VT (US)

(73) Assignee: NOMAD TRANSPORTABLE POWER SYSTEMS, INC., Waterbury, VT (US)

(21) Appl. No.: 18/546,749

(22) PCT Filed: Feb. 16, 2022
(86) PCT No.: PCT/US22/16618

§ 371 Date: Aug. 16, 2023

Related U.S. Application Data
(60) Provisional application No. 63/150,151, filed on Feb. 17, 2021.
(60) Provisional application No. 63/150,195, filed on Feb. 17, 2021.

(51) Int. Cl. H02J 3/32; H02J 7/00

(52) U.S. Cl. CPC H02J 3/32; H02J 7/0047

(57) ABSTRACT

An example of a system to provide energy storage capacity moveable between multiple locations is provided. The system includes a plurality of docking stations, wherein each docking station is connected to a power distribution network. In addition, the system includes an energy storage unit to connect to a first docking station selected from the plurality of docking stations. Furthermore, the system includes a transporter onto which the energy storage unit is mounted to transport the energy storage unit from the first docking station to a second docking station.

### CROSS REFERENCE TO RELATED APPLICATIONS

This application claims priority to and the benefit of U.S. Provisional Application No. 63/150,151 which was filed on Feb. 17, 2021, and U.S. Provisional Application No. 63/150,195 which was filed on Feb. 17, 2021.

### BACKGROUND

Electricity and the delivery of electricity is an important part in industrial development, economic development, and for personal use in daily life. Electricity may be generated to supply a power system or power grid. The demand of the power grid may fluctuate through time, in short intervals such as throughout the day, or over longer periods of time such as seasons of the year. For example, air conditioning energy loads may increase the amount of demand for electricity for the grid during the summer months, while this demand may vanish in the winter months. When the demand for electricity increases, the supply of electricity may not be able to be increased beyond an infrastructure limit. Accordingly, energy sources, such as generating stations are typically designed to provide the peak electricity demanded. When the demand exceeds this amount, the power system may not be able to maintain the specified power requirements of the loads resulting in brownouts, blackouts or increases in power costs as the supplier adjusts and purchases electricity from the active, open market.

Energy storage systems may be used at the utility-scale to balance electricity supply and demand. In particular, lithium-ion batteries provide a high energy efficiency, long cycle life, and high energy density storage platform. Due to the weight and safety issues associated with moving charged utility-scale lithium-ion batteries, they are generally shipped in a partially charged and non-racked state to a location to be installed and charged for use to reduce the likelihood of mechanical damage to the cells when they are in an improperly designed package. Mechanical damage can lead to a cell off-gassing, or even a thermal runaway condition, both of which are fire hazards. Furthermore, temperature and humidity needs to be controlled to within the battery manufacturer's specifications to prevent long-term damage. Accordingly, these utility-scale energy storage systems are generally at a fixed location and involve significant assembly and disassembly processes when the systems are moved from one location to another. In practice, this generally means that lithium-ion batteries are only deployable at a specific location connected to one point on an electric grid where they remain for an extended period of time, for example, for 10-20 years.

There exist some portable energy storage systems. For example, lead-acid battery systems may be used in some portable energy storage systems because of their stability and robustness. However, the chemistry of lead-acid batteries does not provide as much efficiency, cycle life, or energy density as other types of batteries that may be transported in a discharged state to a location for installation, such as a lithium-ion battery system.

### SUMMARY

In accordance with an aspect of the invention, a system is provided. The system includes a plurality of docking stations. Each docking station is connected to a power distribution network. The system further includes an energy storage unit to connect to a first docking station selected from the plurality of docking stations. The energy storage unit is to store energy at a utility-scale to be provided to the power distribution network. Furthermore, the system includes a transporter onto which the energy storage unit is mounted. The transporter is to transport the energy storage unit from the first docking station to a second docking station selected from the plurality of docking stations. The energy storage unit is maintained in a fully assembled state during transportation.

In addition, the power distribution network may be a public power grid. Alternatively, the power distribution network may be a closed power grid. Each docking station may transfer energy from the power distribution network to the energy storage unit to charge the energy storage unit. Furthermore, the docking station may include additional on-site generation inputs such as a photovoltaic array, wind turbine, or conventional fossil fuel generator set to transfer energy to the energy storage unit.

The system may further include racks to mount cells of the energy storage unit to the transporter. The system may further include a monitoring system to monitor the energy storage unit. The system may include a sensor to provide data to the monitoring system. The sensor may be disposed within the transporter. The monitoring system may collect data during transportation. The data collected by the monitoring system is to detect damage to the energy storage unit during transportation. The system may include a meteorological sensor array and recording device. The system may include fire and explosion protections such as an onboard fire suppression system, lithium outgassing detection, automatic fan and dampers for emergency ventilation, and deflagration panels.

Additionally, the system may include a memory storage unit to store the data.

The energy storage unit may have a capacity of at least about 500 kilowatt-hours. Furthermore, the capacity may be at least about 1200 kilowatt-hours. In addition, the capacity may be at least about 2400 kilowatt-hours.

In accordance with an aspect of the invention, an apparatus is provided. The apparatus includes an energy storage unit to connect to a docking station. The energy storage unit is to store energy at a utility-scale to be provided to a power distribution network via the docking station. The apparatus further includes a transporter onto which the energy storage unit is mounted. The transporter is to transport the energy storage unit from a first location to a second location. The energy storage unit is transported in an operational state.

In accordance with an aspect of the invention, a method is provided. The method involves storing energy at a utility-scale in an energy storage unit. The method further involves transporting the energy storage unit to a first docking station. The first docking station is connected to a first power distribution network. In addition, the method involves connecting the energy storage unit to the first docking station. The method also involves providing the energy to first power distribution network from the energy storage unit via the first docking station. The method additionally involves disconnecting the energy storage unit from the first docking station. The method further involves transporting the energy storage unit from the first docking station to a second docking station. In addition, the method involves maintaining the energy storage unit in an operational state during transportation.

### BRIEF DESCRIPTION OF THE DRAWINGS

Reference will now be made, by way of example only, to the accompanying drawings in which:

FIG. 1 is a representation of an example of a system to provide energy storage capacity moveable between multiple locations;

FIG. 2 is a schematic representation of an example of an energy storage unit with a monitoring system;

FIG. 3 is a flowchart of an example of a method of moving a utility-scale energy storage unit between multiple locations in a fully assembled state;

FIG. 4 is a representation of another example of a transporter to transport an energy storage unit;

FIG. 5 is a representation of another example of a transporter to transport an energy storage unit with a control room;

FIG. 6 is a representation of an example of the energy storage unit in the transporter shown in FIG. 5;

FIG. 7 is a representation of another example of the energy storage unit; and

FIG. 8 is a flowchart of another example of a method of moving a utility-scale energy storage unit between multiple locations in a fully assembled state.

### DETAILED DESCRIPTION

The demand for electricity may often fluctuate to create imbalances between power generation and power consumption. In particular, instantaneous demand for electrical energy is often unpredictable from day to day and may depend on various factors such as temperature, industrial manufacturing changes, and seasonal variations. Since electricity storage is generally not used, the variations in the power supply may result in challenges to the power distribution network in terms of electricity generation, transmission, and distribution. To address this issue, a utility-scale energy storage system may be installed in the power distribution network, such as a power grid, to convert and store electricity from an energy source, such as a generator, and to subsequently convert it back into electrical energy to be re-supplied into the power distribution network. In some examples, additional electrical energy above the generation rate of power distribution network during peak demand periods. During these periods, an energy storage system that has been pre-charged with power may supplement the electricity supplied in the power distribution network. Furthermore, it is to be appreciated by a person of skill with the benefit of this description that the use of energy storage unit connected to a power distribution network may provide ancillary benefits such as frequency regulation, voltage support, islanding capabilities, and grid reliability reserves across the entire power distribution network.

Although batteries are now commonly used to provide portable electrical energy on a small scale such as to power electric cars and other apparatus, such as portable equipment at a remote work site, utility-scale energy storage systems with a capacity greater than about 200 kilowatt-hours are generally stationary systems. In particular, utility-scale energy storage systems cannot be transported safely while in a charged or fully assembled state due to the large amount of energy stored, the weight of the batteries, and the inertial forces they generate while in transit. Accordingly, the batteries for utility-scale energy storage solutions are generally transported in a safer non-assembled state, or de-racked state. Therefore, the energy storage system is to be installed or racked up at the final location to be installed in a fixed facility. Prior to moving the batteries of the utility-scale energy storage system, the batteries are to be de-racked and converted into a disassembled state for safe transportation.

A system and method is provided to deliver an energy storage unit, such as a mobile utility-scale energy storage unit, to different locations that may experience temporarily large swings in electricity consumption. The mobile energy storage unit provides a vehicle to store energy to supplement electricity generation during periods of peak electricity usage on a power grid and to receive excess energy for storage during periods of low electricity usage on the power grid. The mobile energy storage unit may be moved from one location to another to avoid idling when the mobile energy storage unit is not used, such as during prolonged periods of low electricity usage. The energy storage unit may be moved from one location to another location in a fully assembled state without having to prepare the energy storage unit for transportation through the use of a standardized quick connect/disconnect docking arm system and docking platform. Accordingly, this allows the energy storage unit to be moved and deployed at a new location quickly.

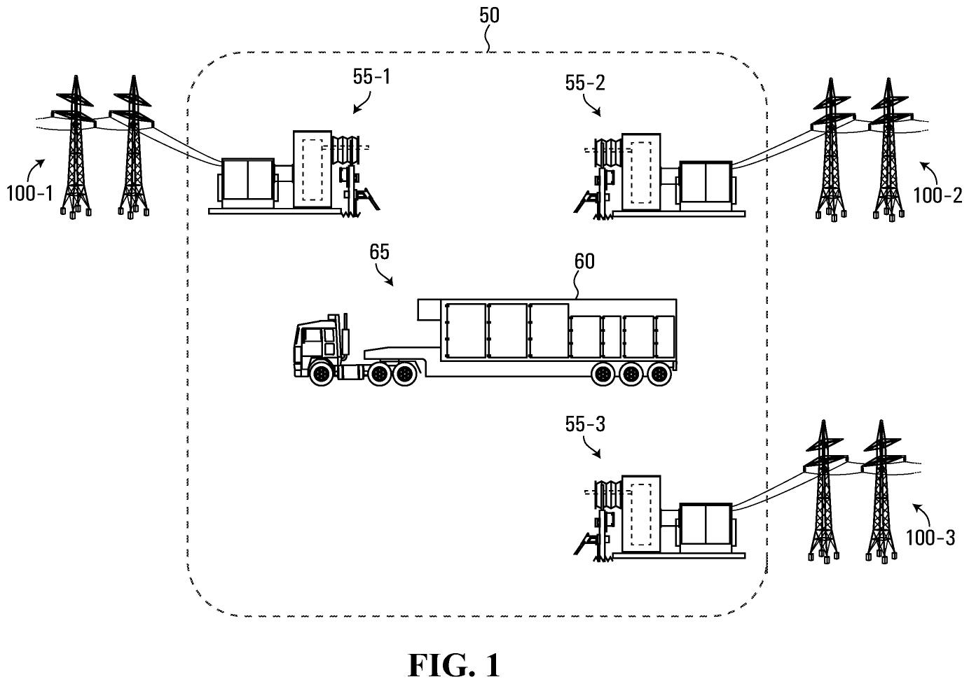

Referring to FIG. 1, a system to provide energy storage capacity moveable between multiple locations is generally shown at 50. It is to be appreciated by a person of skill with the benefit of this description that the system 50 may include additional components, such as control systems, docking mechanisms, environmental sensors, and other devices to move the energy storage units and to connect the energy storage units to the various points of interconnections. In the present example, the system 50 includes docking stations 55-1, 55-2, 55-3 (generically, these docking stations are referred to herein as “docking station 55” and collectively they are referred to as “docking stations 55”), an energy storage unit 60, and a transporter 65.

In the present example, the docking stations 55-1, 55-2, 55-3 are each connected to a power distribution network 100-1, 100-2, 100-3, respectively (generically, these power distribution networks are referred to herein as “power distribution network 100” and collectively they are referred to as “power distribution networks 100”). Each power distribution network 100 is not particularly limited. For example, the power distribution network 100 may be a public utility power grid with an interconnection voltage of about 13.2 kVAC. In other examples, the power distribution network 100 may have an interconnection voltage of about 34.5 kVAC. In further examples, the power distribution network 100 may be interconnected at another medium-voltage level, or the power distribution network 100 may include a single phase interconnection through a modification of the onboard power conversion system. Furthermore, the docking stations 55 may be different interconnections at different geographical locations of the same power grid. In other examples, a power distribution network 100 may be a private system used to power a factory or group of small buildings to supplement a public power grid. In other examples, the power distribution network 100 may be a closed power grid, such as a system to provide electricity to a construction site, a mining site, ski area, disaster relief center, military forward operating base, concert, sporting event, filming location, or other remote locations far from a public power grid.

The docking stations 55 are to provide a connection point to connect the power distribution network 100 to the energy storage unit 60. Accordingly, the docking station 55 transfers energy from the energy storage unit 60 to the power distribution network 100. In some examples, the docking station 55 may also be configured to transfer energy from the power distribution network 100 to the energy storage unit 60 to charge the energy storage unit 60, such as when surplus electricity from the power distribution network 100 is available. In some examples, the docking stations 55 may have additional electricity generation inputs such as a photovoltaic array, wind turbine, or conventional fossil fuel generator which may provide power to the energy storage system to create a microgrid, provide additional resiliency, or integrate a renewable asset.

In the present example, the energy storage unit 60 is to store energy at a utility-scale to provide a power distribution network 100 with electrical energy. For example, the energy storage unit 60 may connect to a docking station 55 via a standardized interconnection interface. Accordingly, the energy storage unit 60 is compatible with multiple docking stations 55 and may be connected and disconnected to a power distribution network 100 quickly and moved between docking stations 55 to reduce idle time and to increase the use of the energy storage unit 60.

The energy storage unit 60 is not particularly limited and may be modified to accommodate a wide variety of applications. In the present example, the energy storage unit 60 provides utility-scale energy storage with a capacity of about 1.2 megawatt-hours. In other examples, the utility-scale energy storage may have a capacity as low as about 500 kilowatt-hours with a power output of about 250 kilowatts. For example, the energy storage unit 60 may provide a storage capacity of about 2.0 megawatt-hours or about 2.4 megawatt-hours. In addition, the energy storage unit 60 may provide electricity at a high peak power to meet demands of the power distribution network 100. For example, the energy storage unit 60 may discharge power at up to about 500 kilowatts in some examples. In other examples, the energy storage unit 60 may discharge power at higher rates of up to about 1 megawatt. The energy storage unit 60 may also discharge at lower rates of power by de-rating the onboard power conversion system through the system supervisory controller to outputs as low as about 100 kilowatts.

In the present example, the energy storage unit 60 include a plurality of lithium-ion batteries. For example, the energy storage unit 60 may include six 17 module racks of KORE MARK 1 lithium-ion batteries. As another example, the energy storage unit 60 may include twelve 17 modules racks of KORE MARK 1 lithium-ion batteries. Other examples may include over twenty 17 module racks of KORE MARK 1 lithium-ion batteries. In some examples, the energy storage unit 60 may also include further components such as an isolation transformer to allow the energy storage unit 60 to operating in an islanding state if a power distribution network 100 fails. The energy storage unit 60 may weigh over about 35,000 kilograms or less than about 10,000 kilograms in some specific examples. In other example, the energy storage unit 60 may weigh about 30,000 kilograms or about 25,000 kilograms. It is to be appreciated by a person of skill with the benefit of this description that the weight of the energy storage unit 60 and the transporter 65 are not limited and correlates with the capacity of the energy storage unit 60. The total weight of the energy storage unit 60 and the transporter 65 may also be selected and designed based on other considerations, such as regulations relating to roads to each docking station 55 or other limits in place for public safety.

It is to be appreciated that the types of battery cells or other storage devices used by the energy storage unit 60 is not particularly limited. In particular, other types of battery cells capable of providing the physical and electrical characteristics may be used. In particular, in order to operate at the utility-scale, the energy storage unit 60 is to have a high capacity and high discharge rate. In this regard, other types of battery cells may not be suitable as they may not be able to provide electricity at a sufficient rate during peak demand or store sufficient energy for a predetermined volume occupied by the battery cells to be useful. As an example, a lead-acid battery generally has a capacity about 15% of a similarly sized lithium-ion battery which means that the amount of volume of lead acid battery used to provide a comparable capacity may be over six times larger. In addition, lead-acid batteries typically have a peak discharge rate (or C-rating) of about twelve percent of a 1C lithium-ion battery, which means that it will be less effective at providing power during peak demand periods.

The transporter 65 is to transport the energy storage unit 60 from one docking station 55 to another docking station 55. For example, the transporter 65 may be used to transport the energy storage unit 60 from the docking station 55-1 to the docking station 55-2 when demand for energy storage from the power distribution network 100-1 decreases, such as due to seasonal demand, while demand for energy storage from the power distribution network 100-2, which may be in a different location, increases.

In the present example, the energy storage unit 60 is mounted onto the transporter 65. In particular, the transporter 65 is configured to mount the energy storage unit 60 such that the energy storage unit 60 may be maintained in a fully assembled state during transportation between docking stations 55. In particular, the energy storage unit 60 may be disconnected from a docking station 55 in a charged state and transported in this operational state. It is to be appreciated by a person of skill with the benefit of this description that transporting an energy storage unit 60 having utility-scale capacities in an operational state may typically be considered dangerous. For example, the forces experienced during transportation, such as from uneven road surfaces, extreme temperatures, collisions and/or forces experienced from acceleration and deceleration may cause a catastrophic failure of the energy storage unit 60 that can result in a fire or explosion without adequate safeguards in place.

The manner by which the energy storage unit 60 is mounted onto the transporter 65 is not particularly limited. For example, racks that are built into the transporter 65. The racks may be custom designed to receive and mount battery cells of the energy storage unit 60 to withstand typical forces experience during transportation. In other examples, the energy storage unit 60 may be mounted using other means such as fasteners, straps and bolts. In addition, the transporter 65 may include additional features such as an air-ride suspension system to dampen vibrations caused by an uneven road surface, thermal insulation and/or a heating, ventilation, and air conditioning system to protect from large temperature swings, a battery cell outgassing detection system to detect, alarm, and/or activate a ventilation system in the event of a module or cell disruption, a fire suppression unit such as a clean agent fire suppression system to improve safety during transportation in the event the energy storage unit 60 malfunctions or catches fire without substantially damaging the equipment during fire suppression or a traditional fire suppression system, such as a dry deluge standpipe leading to a sprinkler system, deflagration panels to vent combustion gases and pressures, and an interior shock absorption system mounted to the top, bottom, and sides of the battery racks apart from the transporter's main air-ride suspension. Accordingly, it is to be appreciated by a person of skill that this configuration may allow for transportation of the energy storage unit 60 having utility-scale capacities in a charged state in a safe manner.

The transporter 65 is also not particularly limited and may include any apparatus capable of safely transporting the energy storage unit 60. In the present example, the transporter 65 is a trailer unit to be towed by a tractor unit. Continuing with the example above of moving the energy storage unit 60 from the docking station 55-1 to the docking station 55-2, the transporter 65 may be parked proximate to the docking station 55-1 with the energy storage unit 60 connected to the docking station 55-1. When the energy storage unit 60 is to be moved to the docking station 55-2, the energy storage unit 60 may simply be disconnected while a tractor unit is attached to the transporter 65 to tow the energy storage unit 60 in the fully assembled state to the docking station 55-2. The transporter 65 may be parked proximate to the docking station 55-2 such that the energy storage unit 60 may be connected to the docking station 55-2 to continue operation. It is to be appreciated that in other examples, the transporter 65 may include an engine unit such that it may be driven to a new location without a separate tractor unit. In further examples, the transporter 65 may be a rail car or placed on a rail car to be transported by train.

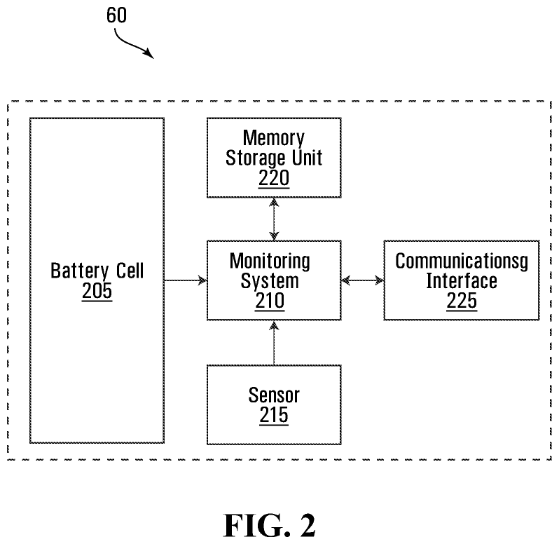

Referring to FIG. 2, the energy storage unit 60 of the present example is shown in greater detail. It is to be appreciated that the energy storage unit 60 is not particularly limited and that variations are contemplated. For example, the energy storage unit 60 may be a sole battery cell or collection of battery cells. In other examples, the energy storage unit 60 may include various control systems and monitoring components. In the present example, the energy storage unit 60 includes at least one battery cell 205, a monitoring system 210, a sensor 215, a memory storage unit 220, and a communications interface 225.

In the present example, the battery cell 205 is a lithium-ion battery cell. It is to be appreciated by a person of skill with the benefit of this description that the battery cell 205 is not particularly limited and may include other energy storage devices having a sufficient capacity, discharge rate, and stability for transportation.

The monitoring system 210 is generally to monitor the battery cell 205 of the energy storage unit. In particular, the monitoring system 210 may receive data provided by the sensor 215. In the present example, the sensor 215 is disposed within the transporter 65 to collect data during transportation. The data measured by the sensor 215 is not particularly limited and may include data that may provide information to confirm that the battery cell 205 has not experience a condition or event that is beyond tolerances. As an example, the sensor 215 may be a temperature sensor disposed near the battery cell 205 to measure the temperature around the battery cell 205. The monitoring system 210 may further include a controller to operate a climate control system within the transporter to maintain a constant temperature within a predetermined operating range. In other examples, a temperature sensor may be used as a safety device to detect a runaway condition to warn a driver, sound an external alarm, or activate a fire suppression system.

In other examples, the sensor 215 may be disposed at another location within the transporter 65 to collect other data during transportation of the energy storage unit 60. For example, the sensor 215 may be an accelerometer to detect the motions of the transporter 65. In this example, the sensor 215 may be used to monitor the forces that the battery cell 205 is subjected to and to provide a warning if the battery cell 205 was subjected to a sudden acceleration or deceleration, such as excessive braking or an accident, during transport that exceeds the limits that the battery cell 205. Therefore, a sensor 215 may be used to collect data that can be used to detect or provide a risk assessment of potential damage suffered by the energy storage unit 60 during transportation. It is to be appreciated by a person of skill with the benefit of this description that location at which the sensor 215 may be mounted is not particularly limited. For example, the sensor 215 may be mounted onto racks where forces on each battery cell 205 may be inferred. In other examples, the sensor 215 may be mounted onto the transporter 65 where forces on each battery cell 205 may be inferred. Further examples may include mounting a sensor 215 on a battery cell 205 so that forces may be measured directly on each battery cell 205.

In further examples, the sensor 215 may be a humidity sensor to measure the humidity around the battery cell 205. In other examples, the sensor 215 may be a sensor to detect off-gassing, which may indicate a failure of the battery cell 205. The monitoring system 210 may then activate an emergency ventilation system, such as to open dampers and turn on a fan, to remove the off-gasses before a flammability limit is reached. As yet another example, the sensor 215 may be a GPS sensor to provide information related to the location of the energy storage unit 60 as well as its speed and estimated time of arrival during transportation. Further examples may include additional sensors to measure multiple types of data.

The memory storage unit 220 is to store the data collected by the sensor 215 or information generated by the monitoring system. In particular, the memory storage unit 220 is to generate a log of events and conditions to which the battery cell 205 was subjected. The memory storage unit 220 is not particularly limited. In the present example, the memory storage unit 220 is a non-transitory machine-readable storage medium that may be any electronic, magnetic, optical, or other physical storage device. In other examples, the memory storage unit 220 may be a separate device external from the energy storage unit 60, such as an external server in the cloud.

The communications interface 225 is to communicate with an external device to which the data about the energy storage unit 60 to be transmitted. In the present example, the communications interface 225 may communicate with an external device over a network, which may be a public cellular network to a central location. In other examples, the communications interface 225 may transmit the data to an external device of the driver such that the driver of the vehicle may monitor the status and conditions of the energy storage unit 60 during transportation.

It is to be appreciated by a person of skill with the benefit of this description that variations to the system 50 are contemplated. For example, the system 50 may include further more energy storage units 60 and more docking stations 55. Accordingly, an additional dispatching system (not shown) may be used to efficiently manage the energy storage units 60 across the various power distribution networks 100.

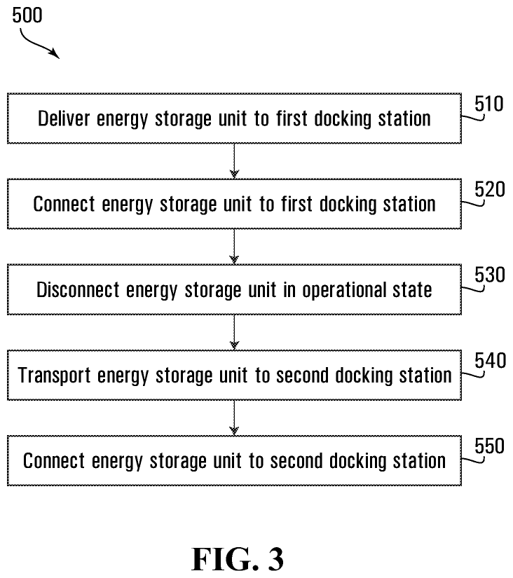

Referring to FIG. 3, a flowchart of a method of moving a utility-scale energy storage unit between multiple locations in a fully assembled state is generally shown at 500. In order to assist in the explanation of method 500, it will be assumed that method 500 may be performed by the system 50. Indeed, the method 500 may be one way in which the system 50 may be operated. Furthermore, the following discussion of method 500 may lead to a further understanding of the system 50 and its components. In addition, it is to be emphasized, that method 500 may not be performed in the exact sequence as shown, and various blocks may be performed in parallel rather than in sequence, or in a different sequence altogether.

Beginning at block 510, an energy storage unit 60 is delivered to a docking station 55-1. The energy storage unit 60 is then connected to the docking station 55-1 at block 520 to provide a utility-scale energy storage solution to the power distribution network 100-1. In particular, the energy storage unit 60 provides additional electricity to the power distribution network 100-1 during peak demand periods and may receive electricity when the power distribution network 100-1 produces surplus electricity. In other examples, if the electricity provided to the power distribution network 100-1 from an external source, such as a public power grid, is subjected to time of use pricing policies, the energy storage unit 60 may be used to charge during periods of low cost electricity and supply electricity during periods of high cost electricity.

When the power distribution network 100-1 no longer uses the energy storage unit 60, it is to be appreciated that the energy storage unit 60 may be moved to another location that may benefit from the energy storage unit 60. At block 530, the energy storage unit 60 may be disconnected from the docking station 55-1 while still in the fully assembled state. The energy storage unit 60 may then be transported to the docking station 55-2 at block 540 where an energy storage solution may be called for to reduce costs or to supplement the power available within the power distribution network 100-2. The energy storage unit 60 is then connected to the docking station 55-2 at block 550 to provide a utility-scale energy storage solution to the power distribution network 100-2.

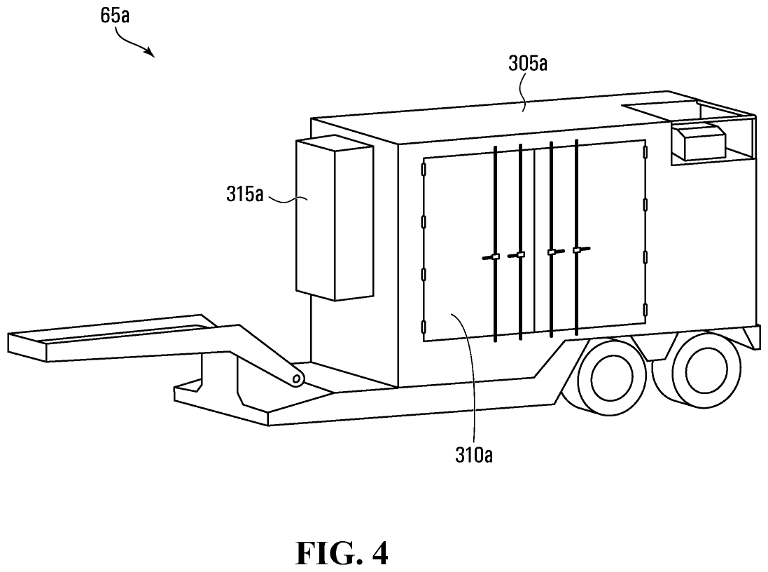

Referring to FIG. 4, another example of a transporter 65a to transport an energy storage unit 60a is shown. It is to be appreciated by a person of skill with the benefit of this description that the transporter 65a is not particularly limited and may include other features to improve the transportation of the energy storage unit 60a from a first location to a second location. For example, the transport 65a may be used as a substitute for the transporter 65 in the system 50. In the present example, the transporter 65a includes an enclosure 305a, a door 310a, and a climate control system 315a.

The enclosure 305a is to protect the energy storage unit 60a and the sensitive equipment, such as lithium-ion battery cells or control systems associated with the lithium-ion battery cells. In particular, the enclosure 305a may shield the lithium-ion cells from weather elements such as wind, rain, snow, dust, or sunlight during operation and during transport between locations. In addition, the enclosure 305 may protect the equipment during transportation from other elements including road hazards, such as rocks and other debris. Furthermore, the enclosure 305 may protect the environment outside in the event of a failure or other hazard. For example, the enclosure 305 may contain a fire of a battery cell. In other examples, the enclosure 305 may include deflagration panels to burst in a pre-determined manner to expel the force of an explosion in a desired direction.

In the present example, the enclosure 305a includes a door 310a to provide access to the energy storage unit 60a. The door 310a is not particularly limited and may be any type of door that can provide access to the energy storage unit 60a, such as for servicing or replacing battery cells. In the present example, the door 310a is a hinged door secured with a latch and/or lock. In other examples, the door 310a may be a sliding door to allow access in more confined spaces.

The climate control system 315a is to regulate and maintain the climate within the enclosure 305a to provide the energy storage unit 60a with consistent operating conditions. The climate control system 315a is not particularly limited and may include a heat pump to maintain the temperature of within the enclosure 305a. Accordingly, the climate control system 315a may be used to remove heat from the enclosure when the temperature exceeds a threshold value or to add heat when the temperature in the enclosure 305a drops below a threshold value. Accordingly, the climate inside the enclosure may be maintained within a narrow band of temperatures, such as between about 19° C. and about 27° C. in the present example. In other examples, the temperature range may be adjusted to accommodate different lithium ion battery cells with different target operating ranges. In some examples, the climate control system 315a may be an air conditioner used to remove heat when the transporter 65a is to operate in hot climates. In other examples, the climate control system 315a may be a heater to add heat either as a heat pump or resistive heater when the transporter 65a is to operate in cold climates. In other examples, the climate control system 315a may include an air heat exchanger in place of a heat pump or in combination with the heat pump to provide more efficient heat removal under some conditions.

It is to be appreciated by a person of skill with the benefit of this description that the climate control system 315a may also regulate the humidity within the enclosure 305a. For example, the climate control system 315a may be a dehumidifier to remove moisture from the air that can cause damage to sensitive electronics operating within the enclosure.

The manner by which the climate control system 315a is powered is not particularly limited. In the present example, the climate control system 315a is connected to the energy storage unit 60a. In this example, an auxiliary transformer may be used to step down the voltage from the energy storage unit 60a to the climate control system 315a as well as other loads such as HVAC systems, lights, outlets, etc. on the transporter 65a. In other examples, the climate control system 315a may be powered using another power source as described in greater detail below. For example, the climate control system 315a may be powered by a tractor pulling the transporter 65a.

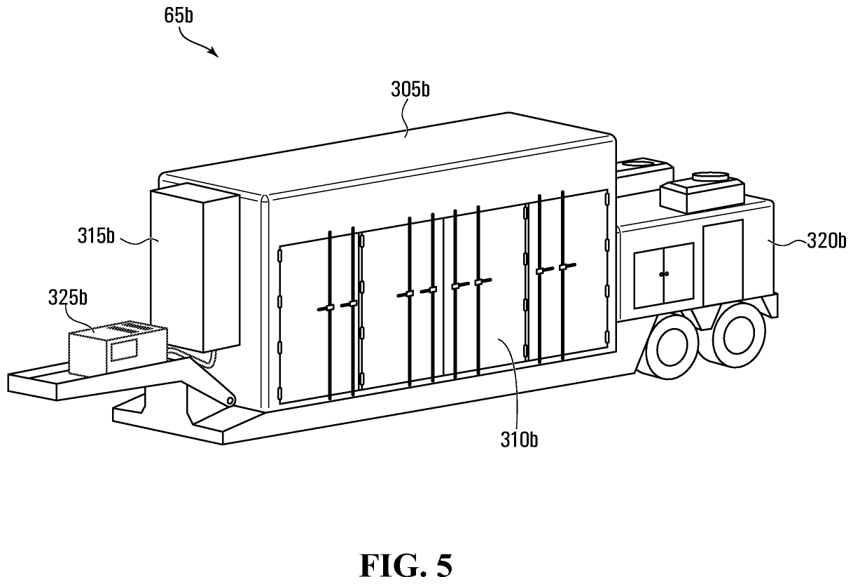

Referring to FIG. 5, another example of a transporter 65b to transport an energy storage unit 60b is shown. Like components of the transporter 65b bear like reference to their counterparts in the transporter 65a, except followed by the suffix “b”. It is to be appreciated by a person of skill with the benefit of this description that the transporter 65b is not particularly limited and may include other features to improve the transportation of the energy storage unit 60b from a first location to a second location. For example, the transport 65b may be used as a substitute for the transporter 65 in the system 50. In the present example, the transporter 65b includes an enclosure 305b, a door 310b, a climate control system 315b, a control room 320b, and a generator 325b.

In the present example, the control room 320b is to house control systems and electrical components of the energy storage unit 60b. For example, the control room 320b may house a controller to operate a monitoring system receiving data from various sensors as well as communications hardware. Furthermore, the control room 320b may include cables and connections to interact with a docking station. The control room 320b may also include an inverter to convert back and forth between direct current and alternating current electricity, a direct current disconnect switch to isolate the batteries, an auxiliary transformer to step down the voltage to power internal loads, a customer interface panel for the customer to control certain aspects of the energy storage unit 60b via a human-machine interface, emergency interlocks to protect equipment, a building and transit load panel to provide a circuit breaker for various loads on components of the apparatus 50b.

The generator 325b is to provide power components of transporter. For example, the generator 325b may be used to power the climate control system 315b and/or electronics and communication systems in the control room 320b. In the present example, the generator 325b is a diesel generator. However, it is to be appreciated that the generator 325b may be any type of generator capable of providing power. In some examples, an additional uninterruptible power source may be combined with the generator 325b to power the components in the control room 320b that may be critical to the operation of the energy storage unit 60b. The uninterruptible power source is not particularly limited and may be a separate battery source, such as a lead acid battery, or may be the energy storage unit 60b.

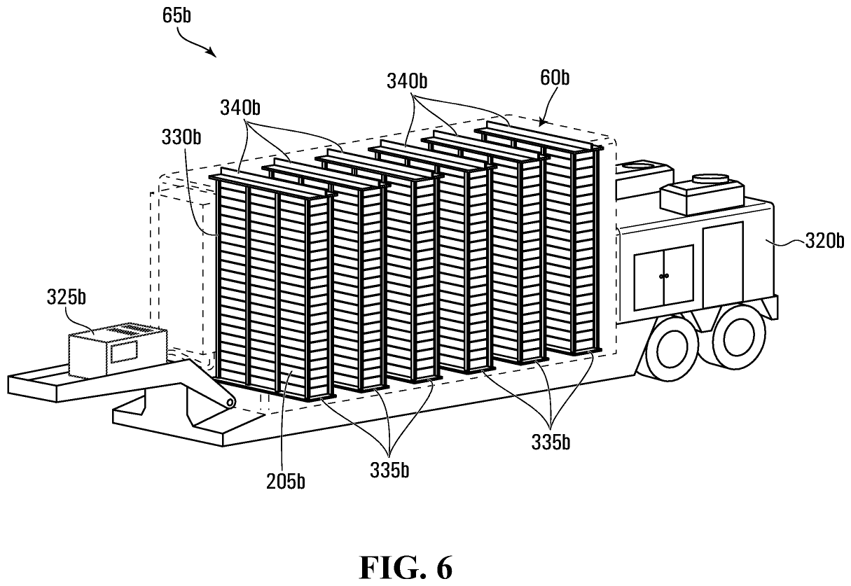

Referring to FIG. 6, an internal configuration of the energy storage unit 60b is shown. In the present example, lithium ion battery cells 205b are mounted into a rack 330b in a vertical configuration. In the present example, the rack 330b may be fastened to the floor of the transporter 65b using a lower fastener 335b. The rack 330b may also be mounted to the ceiling portion of the enclosure 305b of the transporter 65b via upper fasteners 340b to increase the stability of the rack 330b during transportation.

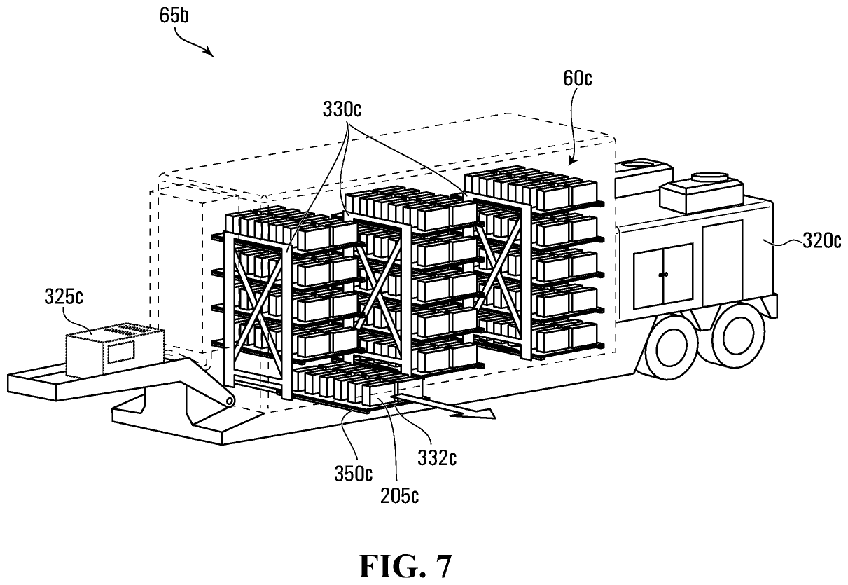

Referring to FIG. 7, another example of and energy storage unit 60c is shown. In the present example, the lithium ion battery cells 205c are mounted into a rack 330c in a horizontal configuration. In the present example, the rack 330c may be mounted on rails 350c to allow a shelf 332c of the rack 330c to slide in and out of the enclosure 305c. It is to be appreciated that in this configuration, access to the lithium ion battery cells 205c is easier since the shelf 332c may slide out of the enclosure 305b to facilitate service or replacement while efficiently utilizing more space within the enclosure 305a. It is to be appreciated by a person of skill that when a shelf of the rack 330b is fully extended, the weight of the lithium ion battery cells 205c may provide a large cantilever weight. In some examples, the rack 330b may be supported by retractable legs with or without wheels (not shown) mounted below shelf of the rack 330b and/or cables (not shown) mounted on top of rack 330b help support this weight.

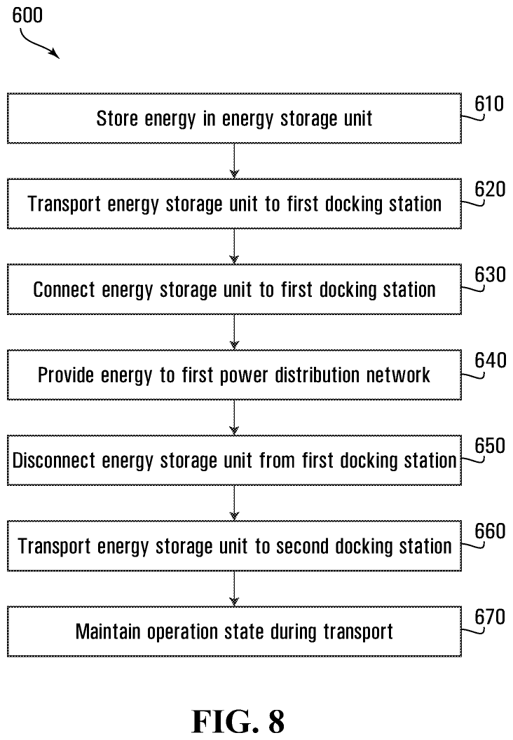

Referring to FIG. 8, a flowchart of another method of moving a utility-scale energy storage unit between multiple locations in a fully assembled state is generally shown at 600. In order to assist in the explanation of method 600, it will be assumed that method 600 may be performed by the system 50. Indeed, the method 600 may be one way in which the system 50 may be operated. Furthermore, the following discussion of method 600 may lead to a further understanding of the system 50 and its components. In addition, it is to be emphasized, that method 600 may not be performed in the exact sequence as shown, and various blocks may be performed in parallel rather than in sequence, or in a different sequence altogether.

Beginning at block 610, energy is stored in the energy storage unit 60 at a utility-scale. For example, the energy storage unit 60 may receive energy via a normal charging process at a power source location. The charged energy storage unit 60 is then to be transported to a docking station 55-1. The manner by which the energy storage unit 60 is transported is not limited and may include being towed by a tractor. In other examples, the transporter 65 may be substituted with rail car to be transported by train. Further examples may include the transporter 65 being substituted with a flotation device for the energy storage unit 60 to be transported over water, such as on a barge.

The energy storage unit 60 is then connected to the docking station 55-1 at block 630. Since the docking station 55-1 is connected to the power distribution network 100-1, the energy storage unit 60 can be utilized to provide energy to the power distribution network 100-1 via the docking station 55-1 at block 640. In particular, the energy storage unit 60 may be used to provide additional electricity to the power distribution network 100-1 during peak demand periods and may receive electricity when the power distribution network 100-1 produces surplus electricity. In other examples, if the electricity provided to the power distribution network 100-1 from an external source, such as a public power grid, is subjected to time of use pricing policies, the energy storage unit 60 may be used to charge during periods of low cost electricity and supply electricity during periods of high cost electricity.

When the power distribution network 100-1 becomes self-sufficient and no longer uses energy from the energy storage unit 60, it is to be appreciated that the energy storage unit 60 may be disconnected from the docking station 55-1 at block 650. It is to be appreciated by a person of skill with the benefit of this description that the reason the power distribution network 100-1 may no longer use power from an energy storage unit for multiple reasons. For example, seasonal fluctuation may be eased if a power source, such as a generator or additional power plant, is added to the power distribution network 100-1. Alternatively, demand on the power distribution network 100-1 may be reduced due to seasonal fluctuations and the demand for appliances like air conditioning. In further examples, the operators of the power distribution network 100-1 may end a service contract with the provider of the energy storage unit 60.

Block 660 involves transporting the energy storage unit 60 to the docking station 55-2. During the transportation of the energy storage unit 60, the battery cells are to be maintained in an operational state as shown in block 670. Upon arriving at the docking station 55-2 connected to the power distribution network 100-2, the energy storage unit 60 is to be connected and provide energy in a similar manner as described in blocks 630 to 650. It is to be appreciated by a person of skill with the benefit of this description that although the above example describes moving the energy storage unit 60 from the docking station 55-1 to the docking station 55-2, that the energy storage unit may be moved between any docking station 55 to provide energy to different power distribution networks 100. Furthermore, while the energy storage unit 60 is connected to a power distribution network 100, the energy storage unit 60 may be charged in periods of low power consumption. Accordingly, the energy storage unit 60 may be generally in a charged state such that when the energy storage unit 60 is to be relocated, the energy storage unit 60 may be connected to the new power distribution network 100 without charging prior to use.

Various advantages will now become apparent to a person of skill with the benefit of this description. In particular, the system 50 provides for a quick connection and disconnection from a utility grid through a process that may typically that does not involve taking the energy storage unit 60 out of the fully assembled state during the disconnection process and re-racking the energy storage unit 60 to be used at a new location. The allows for users to utilize the benefits of an energy storage platform during a defined period of time, such as 100-200 hours per year, when energy storage may be beneficial to costs or to supplement electricity generation during peak demand periods. During periods when the energy storage unit 60 is not used, the energy storage unit 60 may be easily relocated to another location, such as for another user. Accordingly, capital expenditures, insurance, electrical carrying costs, and maintenance may be shared by multiple users.

It should be recognized that features and aspects of the various examples provided above may be combined into further examples that also fall within the scope of the present disclosure.

1. A system comprising:
a plurality of docking stations, wherein each docking station is connected to a power distribution network;
an energy storage unit to connect to a first docking station selected from the plurality of docking stations, the energy storage unit to store energy at a utility-scale to be provided to the power distribution network; and
a transporter onto which the energy storage unit is mounted, wherein the transporter is to transport the energy storage unit from the first docking station to a second docking station selected from the plurality of docking stations, and wherein the energy storage unit is maintained in an operational state during transportation.

2-3. (canceled)

4. The system of claim 1, wherein the transporter includes a climate control system.

5. The system of claim 4, wherein the climate control system is powered by the energy storage unit.

6. The system of claim 4, further comprising a generator to power the climate control system.

7. The system of claim 1, wherein a charger docking station selected from the plurality of docking stations is to transfer energy from the power distribution network to the energy storage unit to charge the energy storage unit.

8. The system of claim 1, further comprising racks to mount cells of the energy storage unit to the transporter.

9. The system of claim 1, further comprising:
a monitoring system to monitor the energy storage unit; and
a sensor to provide data to the monitoring system, wherein the sensor is disposed within the transporter, and wherein the monitoring system is to collect data during transportation.

10-11. (canceled)

12. The system of claim 9, wherein the data collected by the monitoring system is to detect damage to the energy storage unit during transportation.

13. The system of claim 12, wherein further comprising a memory storage unit to store the data.

14. An apparatus comprising:
an energy storage unit to connect to a docking station, wherein the energy storage unit to store energy at a utility-scale to be provided to a power distribution network via the docking station; and
a transporter onto which the energy storage unit is mounted, wherein the transporter is to transport the energy storage unit from a first location to a second location, wherein the energy storage unit is transported in an operational state.

15-16. (canceled)

17. The apparatus of claim 14, wherein the transporter includes a climate control system.

18. The apparatus of claim 17, wherein the climate control system is powered by the energy storage unit.

19. The apparatus of claim 17, further comprising a generator to power the climate control system.

20. The apparatus of claim 14, wherein each docking station is to transfer energy from the power distribution network to the energy storage unit to charge the energy storage unit.

21. The apparatus of claim 14, further comprising racks to mount cells of the energy storage unit to the transporter.

22. The apparatus of claim 14, further comprising:
a monitoring system to monitor the energy storage unit; and
a sensor to provide data to the monitoring system, wherein the sensor is disposed within the transporter, and wherein the monitoring system is to collect data during transportation.

23-24. (canceled)

25. The apparatus of claim 22, wherein the data collected by the monitoring system is to detect damage to the energy storage unit during transportation.

26. The apparatus of claim 25, wherein further comprising a memory storage unit to store the data.

27. A method comprising:
storing energy at a utility-scale in an energy storage unit;
transporting the energy storage unit to a first docking station, wherein the first docking station is connected to a first power distribution network;
connecting the energy storage unit to the first docking station;
providing the energy to first power distribution network from the energy storage unit via the first docking station;
disconnecting the energy storage unit from the first docking station;
transporting the energy storage unit from the first docking station to a second docking station; and
maintaining the energy storage unit in an operational state during transportation.

28. The method of claim 27, wherein the second docking station is to transfer energy from a second power distribution network to the energy storage unit to charge the energy storage unit.

29-32. (canceled)
